(19) United States
(12) Patent Application Publication
(10) Pub. No.: US 2023/0263126 A1
(43) Pub. Date: Aug. 24, 2023

(54) Portable Animal Luggage Device

(71) Applicant: Jill Robicheaux, Baltimore, MD (US)

(72) Inventor: Jill Robicheaux, Baltimore, MD (US)

(21) Appl. No.: 18/170,675

(22) Filed: Feb. 17, 2023

Related U.S. Application Data
(60) Provisional application No. 63/312,636, filed on Feb. 22, 2022.

(51) Int. Cl. A01K 1/02; A01K 1/035; A01K 1/06; A45C 5/02; A45C 5/14; A45C 5/03; A45C 15/00; A45C 13/02; A45C 13/26; A45C 13/10

(52) U.S. Cl. CPC A01K 1/0254; A01K 1/0353; A01K 1/06; A45C 5/02; A45C 5/14; A45C 5/03; A45C 15/00; A45C 13/02; A45C 13/262; A45C 13/103; A45C 13/1076; A45C 13/1069; A45C 2013/267; A45C 2013/1015

(57) ABSTRACT

The present invention relates to a portable animal luggage device used for transporting personal items, pet items, and a pet. The device is primarily comprised of a body comprised of at least one pet bed and at least one drawer. The body preferably has multiple pull-out drawers that allow a user to separate personal items from animal items within the body. A top wall of the body may also be comprised of at least one pet bed to allow a pet to sit on the body as it is pushed or pulled on at least one wheel.

### CROSS-REFERENCE TO RELATED APPLICATION

The present application claims priority to, and the benefit of, U.S. Provisional Application No. 63/312,636, which was filed on Feb. 22, 2022, and is incorporated herein by reference in its entirety.

### FIELD OF THE INVENTION

The present invention relates generally to the field of luggage. More specifically, the present invention relates to a portable animal luggage device primarily comprised of a body, comprised of at least one pet bed and at least one drawer. The body preferably has multiple pull-out drawers that allow a user to separate personal items from animal items within the body. A top wall of the body may also be comprised of at least one pet bed to allow a pet to sit on the body as it is pushed or pulled on at least one wheel. Accordingly, the present disclosure makes specific reference thereto. Nonetheless, it is to be appreciated that aspects of the present invention are also equally applicable to other like applications, devices, and methods of manufacture.

### BACKGROUND

Storing and transporting pets and pet supplies on airplanes, trains, and other commercial travel vehicles can be frustrating and difficult. Further, pet owners may have to place their pets in a cargo area within the vehicle, which can be uncomfortable and stressful for the pet. In addition, storing pet supplies in standard luggage can be frustrating and undesirable. Pet owners may also have to transport their pet within an airport, train station, etc. This normally must be done with a separate pet-carrying bag. This is undesirable, especially if a pet owner is already carrying a plurality of bags, luggage, etc.

Therefore, there exists a long-felt need in the art for an improved luggage device. There also exists a long-felt need in the art for a portable animal luggage device that allows a user to easily store pet supplies in a luggage-like configuration. In addition, there exists a long-felt need in the art for a portable animal luggage device that reduces the number of bags or luggage a pet owner must carry. Further, there exists a long-felt need in the art for a portable animal luggage device that allows an animal to travel on the device during use.

The subject matter disclosed and claimed herein, in one embodiment thereof, comprises a portable animal luggage device. The device is primarily comprised of a body, comprised of at least one pet bed and at least one drawer. In the preferred embodiment, the body has multiple pull-out drawers that allow a user to separate personal items from animal items within the body. A top wall of the body may also be comprised of at least one pet bed to allow a pet to sit on the body as it is pushed or pulled on at least one wheel. The bed or other portion of the body may be comprised of at least one fastener that secures the collar and/or leash of the pet to the device.

In this manner, the portable animal luggage device of the present invention accomplishes all of the foregoing objectives and provides an improved luggage device that allows a user to easily store pet supplies in a luggage-like configuration. In addition, the device reduces the number of bags or luggage a pet owner must carry. Further, the device allows an animal to travel on the device during use, thereby eliminating the need for a user to carry the animal in a separate bag.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable animal luggage device. The device is primarily comprised of a body, comprised of at least one pet bed and at least one drawer. The body of the device preferably resembles any size, shape, and/or configuration of suitcase/luggage known in the art. In the preferred embodiment, the body is also comprised of at least one wheel. The body may also be comprised of at least one handle that is a telescopic, locking, or non-locking luggage handle.

In the preferred embodiment, the body is comprised of at least one lid that attaches to the body via at least one hinge or other fixedly attached means. The lid is also comprised of at least one lid fastener that further secures the lid to the body. The lid may have at least one interior and at least one exterior pocket, each comprised of at least one fastener.

In one embodiment, the top wall of the body is comprised of at least one pet bed that allows a pet to ride on the body as a user push or pulls the body via the wheels. A bottom surface of the bottom wall is preferably comprised of at least one fastener that allows the bed to removably attach to the top wall. As a result, the bed can be removed from the body for cleaning or as otherwise needed.

The body is also comprised of an interior frame, comprised of at least one pull-out drawer. The drawer attaches to the frame via at least one track. In the preferred embodiment, the device is comprised of multiple drawers. In said embodiment, a top wall of one drawer may be comprised of at least one food/water bowl.

Accordingly, the portable animal luggage device of the present invention is particularly advantageous as it provides an improved luggage device that allows a user to easily store pet supplies in a luggage-like configuration. During use, the device reduces the number of bags or luggage a pet owner must carry. Further, the device allows an animal to travel on the device during use, thereby eliminating the need for a user to carry the animal in a separate bag. In this manner, the portable animal luggage device overcomes the limitations of existing luggage and pet-carrying methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a portable animal luggage device of the present invention in a closed position in accordance with the disclosed architecture; and

FIG. 2 illustrates a perspective view of one potential embodiment of a portable animal luggage device of the present invention in an opened and extended position in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved luggage device. There also exists a long-felt need in the art for a portable animal luggage device that allows a user to easily store pet supplies in a luggage-like configuration. In addition, there exists a long-felt need in the art for a portable animal luggage device that reduces the number of bags or luggage a pet owner must carry. Further, there exists a long-felt need in the art for a portable animal luggage device that allows an animal to travel on the device during use.

The present invention, in one exemplary embodiment, is comprised of a portable animal luggage device primarily comprised of a body, comprised of at least one pet bed and at least one drawer. The body of the device preferably resembles any size, shape, and/or configuration of suitcase/luggage known in the art, preferably having at least one wheel. The body may also be comprised of at least one handle that is a telescopic, locking, or non-locking luggage handle.

The body is preferably comprised of at least one lid that attaches to the body via at least one hinge or other fixedly attached means. The lid is also comprised of at least one lid fastener that further secures the lid to the body. The lid may have at least one interior and at least one exterior pocket, each comprised of at least one fastener.

In one embodiment, the top wall of the body is comprised of at least one pet bed that allows a pet to ride on the body as a user push or pulls the body via the wheels. A bottom surface of the bottom wall is preferably comprised of at least one fastener that allows the bed to removably attach to the top wall. As a result, the bed can be removed from the body for cleaning or as otherwise needed.

The body is also comprised of an interior frame. The frame has at least one pull-out drawer. The drawer attaches to the frame via at least one track. In the preferred embodiment, the device is comprised of multiple drawers. In said embodiment, a top wall of one drawer may be comprised of at least one food/water bowl.

Accordingly, the portable animal luggage device of the present invention is particularly advantageous as it provides an improved luggage device that allows a user to easily store pet supplies in a luggage-like configuration. During use, the device reduces the number of bags or luggage a pet owner must carry. Further, the device allows an animal to travel on the device during use, thereby eliminating the need for a user to carry the animal in a separate bag. In this manner, the portable animal luggage device overcomes the limitations of existing luggage and pet-carrying methods known in the art.

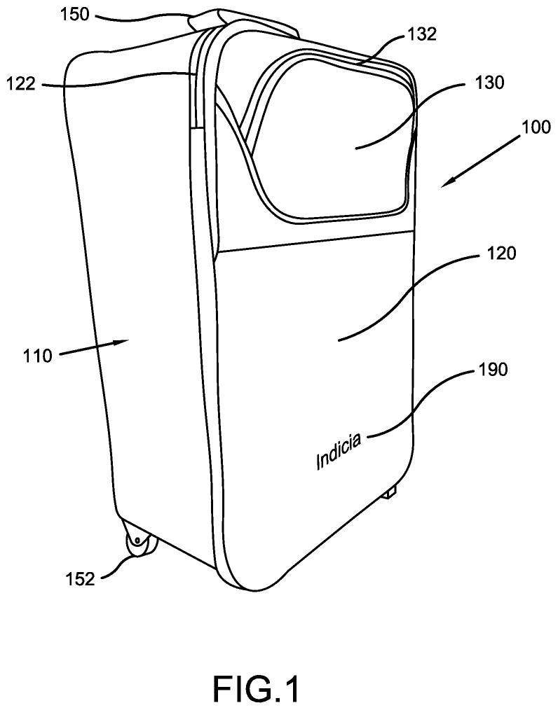

Referring initially to the drawings, FIG. 1 illustrates a perspective view of one potential embodiment of a portable animal luggage device 100 of the present invention in a closed position in accordance with the disclosed architecture. The device 100 is primarily comprised of a body 110, comprised of at least one pet bed 112 and at least one drawer 162. The body 110 of the device 100 preferably resembles any size, shape, and/or configuration of suitcase/luggage known in the art. The body 110 may be made from a plurality of materials such as, but not limited to, polycarbonate, aluminum, ABS, polypropylene, fabric, etc. The body 110 may be comprised of a waterproof material. The body 110 may also be comprised of at least one indicia 190 such as, but not limited to, patterns, logos, emblems, images, symbols, designs, letters, numbers, words, characters, animals, advertisements, brands, etc.

In the preferred embodiment, the body 110 is comprised of at least one wheel 152. The wheel 152 can preferably rotate 360 degrees to allow the device 100 to be pushed or pulled in any direction. The body 110 may also be comprised of at least one handle 150. In the preferred embodiment, the handle 150 is comprised of a telescopic, locking, or non-locking luggage handle. However, the handle 150 may be any handle type known in the art in differing embodiments.

In the preferred embodiment, the body 110 is comprised of at least one lid 120. Some portion of the lid 120 is preferably fixedly attached to the body 110 in one embodiment. In another embodiment, the lid 120 attaches to the body via at least one hinge 124. The hinge 124 may be any hinge type known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

The lid 120 is also comprised of at least one lid fastener 122 that further secures the lid 120 to the body 110. The fastener 122 may fully and/or partially secure the lid 120 to the body 110. The fastener 122 may be any fastener type known in the art such as, but not limited to, a zipper, a snap button, a hook and loop fastener, a magnet, etc.

In one embodiment, the lid 120 is comprised of at least one exterior lid pocket 130. The lid pocket 130 is comprised of at least one lid pocket fastener 132. The fastener 132 may be any fastener type known in the art such as, but not limited to, a zipper, a snap button, a hook and loop fastener, a magnet, etc.

Similarly, in one embodiment the lid 120 is comprised of at least one interior lid pocket 140. The lid pocket 140 is comprised of at least one lid pocket fastener 142. The fastener 142 may be any fastener type known in the art such as, but not limited to, a zipper, a snap button, a hook and loop fastener, a magnet, etc.

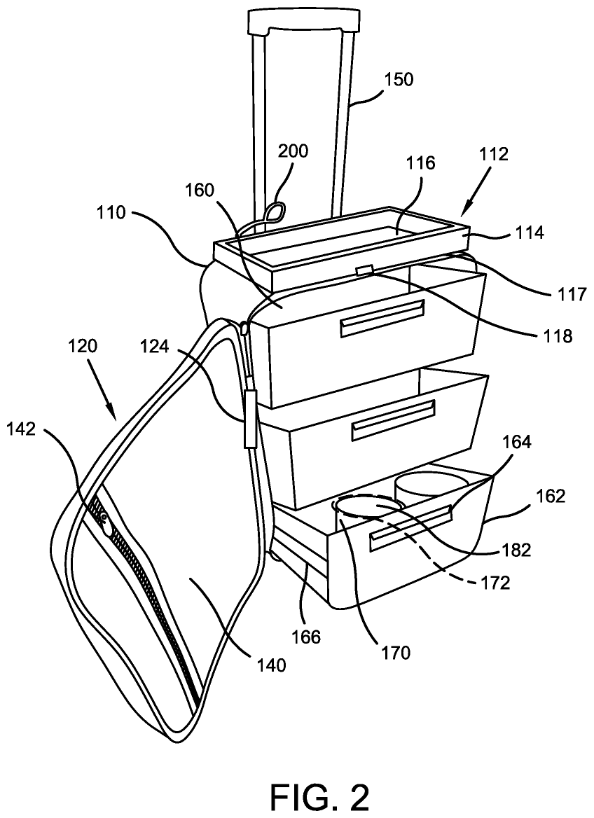

FIG. 2 illustrates a perspective view of one potential embodiment of a portable animal luggage device 100 of the present invention in an opened and extended position in accordance with the disclosed architecture. In one embodiment, the top wall 110 of the body 110 is comprised of at least one pet bed 112. The bed 112 allows a pet to ride on the body 110 as a user push or pulls the body 110 via the wheels 152. The bed 112 may be comprised of at least one side wall 114 and a bottom wall 116. The side wall 114 and bottom wall 116 may be padded, cushioned, and/or rigid. The bottom surface 117 of the bottom wall 116 is preferably comprised of at least one fastener 118 such as, but not limited to, a zipper, a snap button, a hook and loop fastener, a magnet, etc., that allows the bed 112 to removably attach to the top wall 110. In this manner, the bed 112 can be removed from the body 110 for cleaning or as otherwise needed.

The body 110 is also comprised of an interior frame 160, preferably made from a rigid plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The frame 160 is comprised of at least one pull-out drawer 162. The drawer 162 may be comprised of at least one drawer handle 164 of any type known in the art. The drawer 162 attaches to the frame 160 via at least one track 166. The track 166 may be any type of drawer track known in the art. The drawer 162 allows a user to house pet and/or personal related items.

In the preferred embodiment, the device 100 is comprised of multiple drawers 162 to allow users to separate personal items and pet items. In said embodiment, a top wall 170 of one drawer 162 may be comprised of at least one bowl 182. The bowl 182 may be any type of pet food/water bowl known in the art. The bowl 182 preferably rests within at least one opening 172 of the top wall 170 such that it can be easily removed as needed.

In one embodiment, the device 100 is comprised of at least one leash or collar fastener 200 located on the body 110, bed 112, and/or handle 150. The fastener 200 allows a collar and/or leash of an animal to be secured to the device 100 to further secure the animal to the device 100 during use. The fastener may be any fastener type known in the art such as, but not limited to, a clip, a buckle, a clasp, etc. It should be appreciated that the device 100 may have all commonly known features of all luggage known in the art.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable animal luggage device” and “device” are interchangeable and refer to the portable animal luggage device 100 of the present invention.

Notwithstanding the foregoing, the portable animal luggage device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the portable animal luggage device 100 as shown in the FIGS. are for illustrative purposes only, and that many other sizes and shapes of the portable animal luggage device 100 are well within the scope of the present disclosure. Although the dimensions of the portable animal luggage device 100 are important design parameters for user convenience, the portable animal luggage device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable animal luggage device comprising:
a body;
a wheel;
a handle;
a lid;
a pet bed; and
a drawer.

2. The portable animal luggage device of claim 1, wherein the body is comprised of a polycarbonate, an aluminum, an ABS, a polypropylene or a fabric material.

3. The portable animal luggage device of claim 1, wherein the wheel can rotate 360 degrees.

4. The portable animal luggage device of claim 1, wherein the handle is a telescopic handle.

5. A portable animal luggage device comprising:
a body;
a wheel;
a handle;
a lid attached to the body;
a pet bed positioned on a top wall of the body; and
a drawer attached to an interior frame via a track, wherein the interior frame is positioned within the body.

6. The portable animal luggage device of claim 5, wherein a first portion of the lid is fixedly attached to the body.

7. The portable animal luggage device of claim 6, wherein a second portion of the lid is attached to the body via a lid fastener.

8. The portable animal luggage device of claim 7, wherein the lid fastener is comprised of a zipper, a snap button, a hook and loop fastener or a magnet.

9. A portable animal luggage device comprising:
a body;
a wheel;
a telescopic handle;
a lid attached to the body, the lid comprised of a pocket comprised of a pocket fastener;
a pet bed positioned on a top wall of the body, the pet bed attached to the top wall via a pet bed fastener; and
a drawer attached to an interior frame via a track, wherein the interior frame is positioned within the body.

10. The portable animal luggage device of claim 9, wherein the telescopic handle is a locking telescopic handle.

11. The portable animal luggage device of claim 9, wherein the lid attaches to the body via a hinge.

12. The portable animal luggage device of claim 9, wherein the pocket is positioned on an exterior surface of the lid.

13. The portable animal luggage device of claim 9, wherein the pocket is positioned on an interior surface of the lid.

14. The portable animal luggage device of claim 9, wherein the pocket fastener is comprised of a zipper, a snap button, a hook and loop fastener or a magnet.

15. The portable animal luggage device of claim 9, wherein the pet bed fastener is comprised of a zipper, a snap button, a hook and loop fastener or a magnet.

16. The portable animal luggage device of claim 9 further comprised of a leash or collar fastener comprised of a clip, a buckle or a clasp.

17. The portable animal luggage device of claim 9, wherein a top wall of the drawer is comprised of an opening.

18. The portable animal luggage device of claim 17, wherein the opening is sized and configured to receive a bowl.

19. The portable animal luggage device of claim 9, wherein the pet bed is comprised of a rigid side wall.

20. The portable animal luggage device of claim 9, wherein the pet bed is comprised of a cushioned bottom wall.
